(19) United States
(12) Patent Application Publication
(10) Pub. No.: US 2025/0322319 A1
(43) Pub. Date: Oct. 16, 2025

(54) INVITING CO-TRAVELERS TO VIEW A RESERVATION

(71) Applicant: Airbnb, Inc., San Francisco, CA (US)

(72) Inventors: Alan Matthew Wright, Kirkland, WA (US); Leo William Wong, San Francisco, CA (US); Henry Alexander Johnson, Pasadena, CA (US); Jiazhen Chen, Santa Clara, CA (US)

(21) Appl. No.: 18/631,419

(22) Filed: Apr. 10, 2024

(51) Int. Cl. G06Q 10/02

(52) U.S. Cl. CPC G06Q 10/02

(57) ABSTRACT

A system that enables co-travelers to view accommodation reservations is described. The system receives, by a network site of a listing network platform, a request from a user to book a reservation. The system determines that the reservation is associated with one or more guests and, in response to determining that the reservation is associated with the one or more guests, presents a graphical object that represents the reservation with an option to invite the one or more guests to access a portion of information associated with the reservation on the listing network platform. The system transmits the graphical object to one or more devices associated with the one or more guests to enable the one or more guests to access the portion of information associated with the reservation on the listing network platform.

### TECHNICAL FIELD

The present disclosure generally relates to special-purpose machines that manage data processing and improvements to such variants, and to the technologies by which such special-purpose machines become improved compared to other special-purpose machines for accessing a property listings site for reservations.

### BACKGROUND

Network site users can create content for viewing and interaction by other network site users (e.g., booking, registering, subscribing, viewing of listings). The posted content can be updated, created, or deleted, and it can be computationally challenging for a network site to return valid search results to network site users searching for content (e.g., listings for reservations) with specified parameters (e.g., dates, categories, prices, quantity). For example, if there are a large number of users posting and updating content and also a large number of users submitting complex searches for the posted content, any delay in computation due to query complexity may cause inaccurate results to be returned and cause large computational resource consumption (e.g., processing, memory, network overhead). Further challenges exist when one user desires to share interest in a particular listing with another user.

### BRIEF DESCRIPTION OF THE DRAWINGS

Various of the appended drawings merely illustrate example embodiments of the present disclosure and should not be considered as limiting its scope.

FIG. 1 is a block diagram illustrating a listing sharing system implemented in a networked environment, according to some examples.

FIG. 2 shows an example of functional engines of a listing sharing system, according to some examples.

FIG. 3 shows a listings network site user interface generated by the listing network platform and listing sharing system (or listing search system), according to some examples.

FIG. 4 shows different groups of templates used by the listing sharing system, according to some examples.

FIGS. 5 and 6 show example user interfaces of the listing sharing system, according to some examples.

FIGS. 7-9 show flow diagrams of various processes and methods for sharing access to listings on the listing network site, according to some examples.

FIG. 10 is a block diagram illustrating the architecture of software used to implement the disclosed system, according to some examples.

FIG. 11 shows a machine as an example computer system with instructions to cause the machine to implement the disclosed system, according to some examples.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Navigating the vast array of content available on the network site can be very complex and time consuming. Such navigation can entail browsing multiple pages of information to find a suitable result or action. To this end, a listing sharing system can be configured to efficiently share access to specific listings of interest between users. Although in the following discussion the example posted content are accommodations listings (e.g., listings for reservations) posted on a network site, other types of network site content posted and shared by end users can likewise be implemented in the listing sharing system processes and methods, such as transportation, experiences, and/or events.

Generally, a listing platform can be searched for result listings that are available for a specified date range, price range, and/or other attributes (amenities, cancelation policy, etc.), which can be specified in a given query (e.g., text field, drop-down menu, checkbox filters). To search and browse the listing platform, users can access the listing platform on a particular user interface channel, such as by phone or through an application associated with the listing platform. Once users find a listing for an accommodation (reservation) of interest, the users can request to book the accommodation. Sometimes, the reservation involves many other guests that may be staying at the same accommodation during the same reservation window. Informing the guests about the reservation details is usually complicated, time consuming and prone to errors.

Specifically, typical systems enable a particular user to book a reservation. The user then has to individually compose messages directed to specific guests to inform them about the details of the reservations. Such messages are composed manually and are prone to human error. Even still, once the messages are sent to the guests, the guests may have follow-up questions which further burden the user with having to generate suitable responses. To alleviate these issues, users sometimes share their login credentials to the network site to enable the guests to view the details of the reservation. The sharing of the login credentials is prone to security breaches and can result in undesired consequences. There is no way for users to securely share access to listings for reservations with select guests and to limit access and modification rights that the guests have in viewing the listings.

Current reservation systems often present technical challenges due to their design, which typically centralizes control and access to booking details under the account of the individual who made the reservation. This can lead to a lack of direct access for additional guests, who must depend on the primary booker to receive information and updates. Such a setup restricts guests' ability to modify reservations independently, which can be particularly inconvenient if the primary booker is unreachable. Guests also face limited visibility into the reservation's specifics, such as room types, special requests, or changes to the booking, which can cause issues, especially if they are arriving separately.

The dependency on the primary booker for managing the reservation process can create complications if they are unable to fulfill this role due to unforeseen circumstances. Privacy concerns also arise when sharing reservation details, as it may involve sharing personal login credentials, posing a security risk. Without individual access, the reservation system does not allow for personalization or special requests from other guests, and communication from the reservation system, including important notifications and reminders, is typically only sent to the primary booker. For group travel, these limitations can lead to inefficiencies in planning and coordination, as only one person has access to the reservation details. In emergency situations, if the primary booker cannot communicate with the property or the reservation system, other guests may struggle to obtain necessary information or take action regarding the reservation.

The centralized nature of current reservation systems, where only the primary booker has access to reservation details, can lead to inefficient use of system resources in several ways. Firstly, the lack of direct access for additional guests often results in an increased volume of customer service inquiries. Guests without access may frequently contact customer support for information that could be easily obtained through direct access to the reservation details, leading to higher call volumes and longer wait times for all customers seeking assistance. Secondly, the inability of guests to make modifications or updates to their reservations can result in a higher number of last-minute changes or cancellations. These changes often require manual intervention from customer service representatives, consuming more time and resources than if guests could self-manage their reservations. Additionally, the primary booker becomes a bottleneck for information dissemination. They must manually forward all communications, such as confirmations and updates, to the other guests. This not only increases the risk of miscommunication but also places an unnecessary burden on the primary booker to act as an intermediary, which could be streamlined with a more inclusive system.

To address these technical problems, the disclosed techniques provide a network site that allows a user share access to a listing for a reservation with one or more guests in an efficient manner. Namely, the network site can receive a request from a user to book a reservation. The network site determines that the reservation is associated with one or more guests and, in response to determining that the reservation is associated with the one or more guests, presents a graphical object that represents the reservation with an option to invite the one or more guests to access a portion of information associated with the reservation on the listing network platform. The network site transmits the graphical object to one or more devices associated with the one or more guests to enable the one or more guests to access the portion of information associated with the reservation on the listing network platform.

In some examples, the network site receives input from an operator of a listing network platform that defines visual attributes of each template of a plurality of templates and selection criteria associated with each template of the plurality of templates. The network site stores the plurality of templates each associated with a different group of a set of groups, each template of the plurality of templates including visual information that represents a location for a reservation on the listing network platform. The network site selects an individual template of the plurality of templates based on information associated with a listing identifier and generates the graphical object to represent the reservation corresponding to the listing identifier using the individual template that has been selected.

In these ways, the disclosed techniques reduce the amount of computational resources needed to be dedicated and consumed by the system in cases of group travel reservations which frees up such resources for other tasks and satisfying other requests.

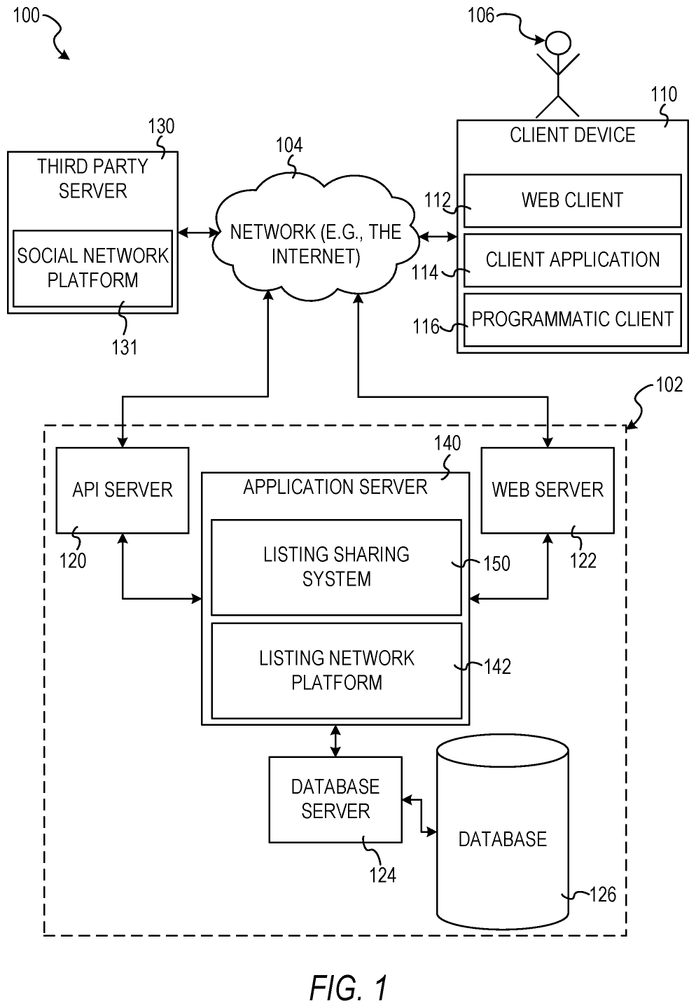

With reference to FIG. 1, an example of a high-level client-server-based network architecture 100 is shown. A networked system 102, in the example form of a network-based listing services system, provides server-side functionality via a network 104 (e.g., the Internet or wide area network (WAN)) to one or more client devices 110 (e.g., also referred to as user systems or user devices). In some implementations, a user (e.g., user 106) interacts with the networked system 102 using the client device 110.

FIG. 1 illustrates, for example, a web client 112 (e.g., a browser), a client application(s) 114, and a programmatic client 116 executing on the client device 110. The client device 110 includes the web client 112, the client application(s) 114, and/or the programmatic client 116 alone, together, or in any suitable combination. Although FIG. 1 shows one client device 110, in other implementations, the network architecture 100 comprises multiple client devices. Depending on the circumstances, the client device 110 can be used by an operator or developer of the application(s) 114 or by an end user of the application(s) 114. For example, the developer of the application(s) 114 can use the client device 110 to define visual attributes and selection criteria for generating templates for postcards that are used to represent different listings. As another example, the user of the application(s) 114 can access the listing network platform 142 to share graphical objects (e.g., postcards generated according to the corresponding templates) with one or more guests that are co-traveling with the user to a destination (e.g., one or more guests defined by the user as being associated with the same reservation).

In various implementations, the client device 110 can include a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box (STB), network personal computer (PC), mini-computer, and so forth. In an example, the client device 110 includes one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FI®) network, a Worldwide Interoperability for Microwave Access (WiMax) network, another type of network, or any suitable combination thereof. In communicating with the network 104 through the first user interaction channel, the client device 110 may only send audio or voice data to the network 104. In communicating with the network 104 through the second user interaction channel, the client device 110 may send data representing selections on a GUI, image content, and/or audio or voice data to the network 104.

In some examples, the client device 110 includes one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps”), and reservation applications for temporary stays or experiences at hotels, motels, or residences managed by other end users (e.g., a posting end user who owns a home and rents out the entire home or private room). In some implementations, the client application(s) 114 include various components operable to present information to the user and communicate with the networked system 102. In some examples, if the e-commerce site application is included in the client device 110, then this application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment). Conversely, if the e-commerce site application is not included in the client device 110, the client device 110 can use its web browser to access the e-commerce site (or a variant thereof) hosted on the networked system 102.

The web client 112 accesses the various systems of the networked system 102 via the web interface supported by a web server 122. Similarly, the programmatic client 116 and client application(s) 114 accesses the various services and functions provided by the networked system 102 via the programmatic interface provided by an Application Program Interface (API) server 120.

Users (e.g., the user 106) can include a person, operator, developer, a machine, a large language model (LLM), machine learning model, or other means of interacting with the client device 110. In some examples, the user 106 is not part of the network architecture 100, but interacts with the network architecture 100 via the client device 110 or another means. For instance, the user 106 provides input (e.g., touch screen input or alphanumeric input) to the client device 110 and the input is communicated to the networked system 102 via the network 104 by way of the second user interaction channel. In this instance, the networked system 102, in response to receiving the input from the user 106, communicates information to the client device 110 via the network 104 to be presented to the user 106. In this way, the user 106 can interact with the networked system 102 using the client device 110. As another example, the user 106 provides input (e.g., speech input) to the client device 110 and the input is communicated to the networked system 102 via the network 104 in the form of audio packets or audio data.

The API server 120 and the web server 122 are coupled to, and provide programmatic and web interfaces respectively to, one or more application server(s) 140. The application server(s) 140 may host a listing network platform 142 and a listing sharing system 150, each of which comprises one or more modules or applications and each of which can be embodied as hardware, software, firmware, or any combination thereof. The application server(s) 140 are, in turn, shown to be coupled to one or more database server(s) 124 that facilitate access to one or more information storage repositories or database(s) 126. In an example, the database(s) 126 are storage devices that store information to be posted (e.g., inventory, image data, catalog data, postcard templates, and so forth) to the listing network platform 142. The database(s) 126 also stores digital goods information in accordance with some examples.

Additionally, a social network platform 131 is illustrated as executing on third-party server(s) 130. Further, the social network platform 131 can programmatically access the networked system 102 via the programmatic interface provided by the API server 120. The social network platform 131 may include a social network website, messaging platform, and one or more APIs. In some examples, the electronic message discussed below is a message sent to a given user via the social network platform 131 messaging system (e.g., social media chat message, post, ping (a “hello” notification), and so on).

The listing network platform 142 provides a number of publication functions and listing services to the users who access the networked system 102. While the listing network platform 142 is shown in FIG. 1 to form part of the networked system 102, it will be appreciated that, in alternative examples, the listing network platform 142 may form part of a web service that is separate and distinct from the networked system 102.

While the client-server-based network architecture 100 shown in FIG. 1 employs a client-server architecture, the disclosed techniques are not limited to such an architecture, and can equally be implemented in a distributed, or peer-to-peer, architecture system, for example. The various systems of the applications server(s) 140 (e.g., the listing network platform 142 and listing sharing system 150) may also be implemented as standalone software programs, which do not necessarily have networking capabilities.

The listing network platform 142 can be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components access one or more database(s) 126 via the database server(s) 124. The listing network platform 142 provides a number of publishing and listing mechanisms whereby a seller (also referred to as a “first user,” posting user, host) may list (or publish information concerning) goods or services for sale or barter, a buyer (also referred to as a “second user,” searching user, guest) can express interest in or indicate a desire to purchase or barter such goods or services, and a transaction (such as a trade) may be completed pertaining to the goods or services.

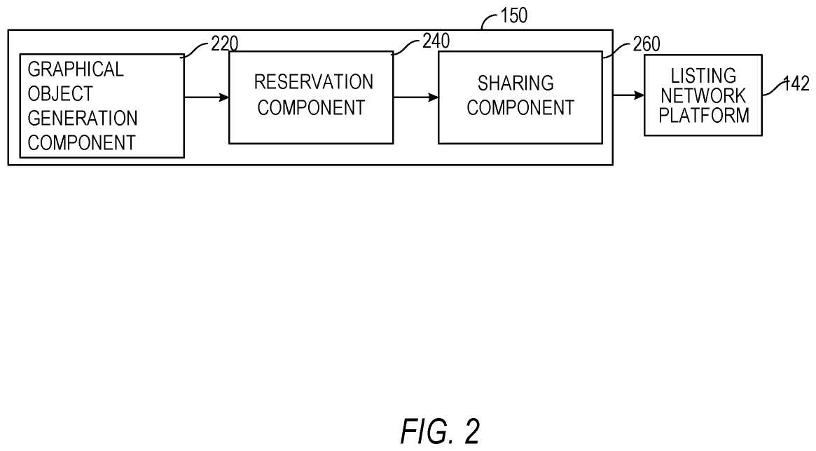

FIG. 2 shows example functional engines of the listing sharing system 150, according to some examples. As illustrated, the listing sharing system 150 includes a graphical object generation component 220, a listing network platform 142, a reservation component 240 (e.g., reservation management and/or generation component), and a sharing component 260. In some examples, the graphical object generation component 220 enables a developer or operator to define visual attributes and selection criteria for various templates. The templates can be used to generate graphical objects or postcards to represent individual reservations, listings, and/or accommodations.

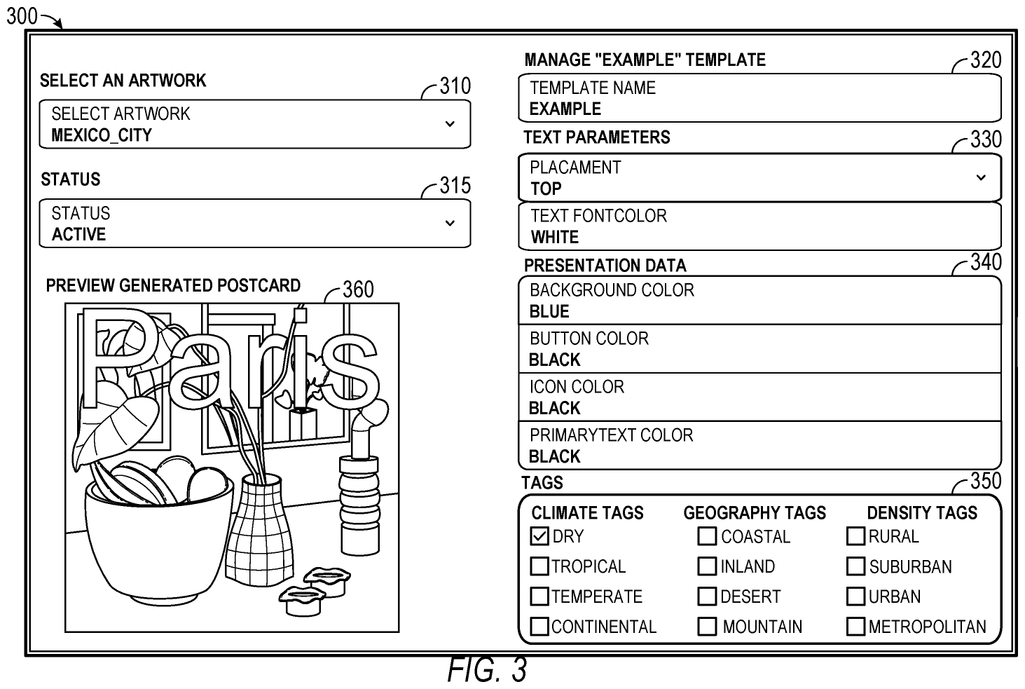

Specifically, the graphical object generation component 220 can present a graphical user interface 300, shown in FIG. 3. The graphical user interface 300 can be presented on the client device 110 of a developer, designer, or operator of the listing sharing system 150. The graphical user interface 300 can include an artwork selection region 310, a status region 315, a preview region 360, a name region 320, a textual parameters region 330, a visual information region 340, and/or a destination tags region 350.

In some examples, the graphical user interface 300 receives input that selects the artwork selection region 310. In response, a list of previously defined templates can be presented. The graphical user interface 300 can receive input that selects a particular template from the list of previously defined templates. In such cases, the graphical user interface 300 obtains the visual attributes and selection criteria associated with the selected template and populates all the fields of the various regions shown in graphical user interface 300 with the previously defined information. The graphical user interface 300 can receive input that modifies or adjusts any one of the fields that are presented to update parameters associated with the selected template.

In some examples, a new template can be defined. In such cases, the graphical user interface 300 can receive input that selects a new template indicator from the list presented based on selection of the artwork selection region 310. In such cases, a generic template can be presented in the preview region 360 and all the other fields shown in graphical user interface 300 can be blank. The graphical user interface 300 can receive input that selects or taps the preview region 360. The graphical user interface 300 can present a window that enables the user to upload a new artwork or new image to associate with the new template. In some cases, rather than uploading the new artwork, the graphical user interface 300 can enable the user to specify a remote storage location on a third-party server that hosts various images to associate with the new template.

The status region 315 can be updated to indicate whether the current template is active and available for use by the graphical object generation component 220 to represent various listings or is in the draft phase. While in the draft phase, the template identified by the artwork selection region 310 is prevented from being used to generate graphical objects to represent listings. The graphical user interface 300 can receive input that selects the name region 320. In response, the graphical user interface 300 can receive input that specifies a name or other identifier for the new template being defined.

Selection information or criteria can be defined in many ways for the new template. In some cases, the selection information can include an identification of specific listing identifiers. For example, the graphical user interface 300 can receive input that specifies a unique identifier or reference to one or more listings available on the listing network platform 142. In response, the graphical object generation component 220 associates the unique identifier with the new template corresponding to the name provided in the name region 320.

For example, the graphical user interface 300 can receive input that specifies a city name, state name, POI name, and so forth. In response, the graphical object generation component 220 associates the city name, state name, and/or POI name with the new template corresponding to the name provided in the name region 320. A save option can be selected from the graphical user interface 300 to save the new template on the listing network platform 142. Once the new template is saved, the new template can be added to the list of templates presented in the artwork selection region 310 using the previously specified name or identifier provided in the name region 320.

In some examples, the graphical user interface 300 receives input that selects the textual parameters region 330. In response, the graphical object generation component 220 receives input that defines a look and visual attributes of text that is to be added to the image shown in the preview region 360. For example, the look and visual attributes can include a font size, font style, font placement, font color, font animation, and so forth. The preview region 360 can show an example font overlaid on the image according to the visual attributes and look defined by the textual parameters region 330.

In some examples, the graphical user interface 300 receives input that selects the visual information region 340. In response, the graphical object generation component 220 receives input that defines a look and visual attributes of a background, button, icons, primary text and so forth to be added to the image shown in the preview region 360. The preview region 360 can show an example background and icons overlaid on the image according to the visual attributes and look defined by the visual information region 340.

In some examples, the graphical user interface 300 receives input that specifies one or more destination tags in the destination tags region 350. For example, the graphical user interface 300 can receive a selection of an option to automatically populate the destination tags region 350. In response, the graphical user interface 300 can receive input that specifies a latitude/longitude, GPS coordinates, city name, state name, POI name, and so forth associated with the new template. The graphical object generation component 220 can receive the input from the graphical user interface 300 and can generate a prompt that includes the specified latitude/longitude, GPS coordinates, city name, state name, and/or POI name with a request to generate a list of destination tags, including climate tags, geography tags, population tags, density tags, cultural tags, and so forth.

The graphical object generation component 220 provides the prompt to an LLM. The LLM processes the prompt and generates automatically the list of requested tags associated with the latitude/longitude, GPS coordinates, city name, state name, and/or POI name. The graphical object generation component 220 updates the destination tags region 350 with the automatically generated information. The graphical user interface 300 can then receive input from the operator or designer that de-selects one or more destination tags (or taxonomy tags) and/or selects new destination tags to associate with the new template. The information provided in the destination tags region 350 defines taxonomy information for the template. Each template selected by the artwork selection region 310 can include a respective set of taxonomy information. Some templates may exclude taxonomy information entirely. The taxonomy information can be referred to as a knowledge graph associated with the various templates and/or destination tags.

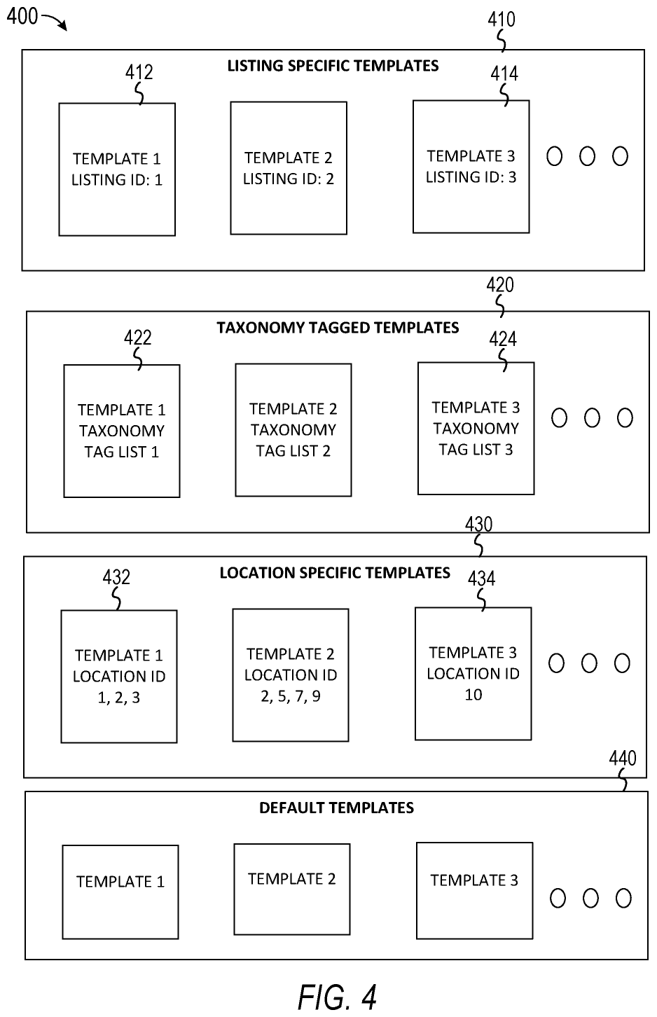

A save option can be selected from the graphical user interface 300 to save the new template on the listing network platform 142. Once the new template is saved, the new template can be added to the list of templates presented in the artwork selection region 310 using the previously specified name or identifier provided in the name region 320. For example, as shown in the list of templates 400 of FIG. 4, the new template can be added to a particular group of templates stored by the listing network platform 142. For example, the list of templates 400 can include a first group of templates 410, a second group of templates 420, a third group of templates 430, and a fourth group of templates 440.

In some examples, the first group of templates 410 includes templates that are associated with specific listing identifiers. For example, the first group of templates 410 includes a first template 412 that is associated with a first set of listing identifiers and a second template 414 that is associated with a second set of listing identifiers. The second group of templates 420 (e.g., taxonomy tagged templates) includes a first template 422 that is associated with a first set of destination (or taxonomy) tags (e.g., taxonomy information including specific geographic, density, and/or climate tags) and a second template 424 that is associated with a second set of destination (or taxonomy) tags (e.g., taxonomy information including specific geographic, density, and/or climate tags). Templates that are added to the second group of templates 420 can exclude listing identifiers. Templates that are added to the first group of templates 410 may or may not include destination tags. The third group of templates 430 includes a first template 432 that is associated with a first set of location identifiers (e.g., latitude/longitude, GPS coordinates, city name, state name, POI name) and a second template 424 that is associated with a second set of location identifiers (e.g., latitude/longitude, GPS coordinates, city name, state name, POI name). Templates that are added to the third group of templates 430 can exclude location identifiers. Templates that are added to the first group of templates 410 may or may not include location identifiers. The fourth group of templates 440 can include a set of templates that are generic or default and exclude any one of the location identifiers, listing identifiers, and/or taxonomy information.

As an example, the graphical object generation component 220 receives input that selects a save option for a new template. In response, the graphical object generation component 220 can determine whether a listing identifier is associated with the new template (e.g., whether the user has provided a listing identifier in the graphical user interface 300). If so, the graphical object generation component 220 adds the new template to the first group of templates 410. If not, the graphical object generation component 220 adds the new template to the second group of templates 420. In some cases, the graphical object generation component 220 determines whether a location identifier has been provided in the graphical user interface 300 for the new template. If so, the graphical object generation component 220 adds the new template to the third group of templates 430 instead of, or in addition to, the second group of templates 420. In some cases, the graphical object generation component 220 adds the new template to the fourth group of templates 440 if the graphical object generation component 220 determines that the new template is not associated with a location identifier or listing identifier and/or excludes taxonomy information.

In some examples, the graphical object generation component 220 generates graphical objects (e.g., postcards) representing an individual listing to be shared with one or more guests based on the list of templates 400. In some cases, the graphical object generation component 220 generates the graphical objects in real time in response to receiving input that selects an option to share a listing with one or more guests. In some examples, the graphical object generation component 220 pre-generates the graphical objects in a background process when a listing for an accommodation is created by a host or at some point after the listing is created and before the listing is selected by an end user to generate a reservation.

In order to generate the graphical object, the graphical object generation component 220 obtains a selected listing. The selected listing can be chosen at random from a set of listings, can be chosen based on a creation date of the listing by a host, and/or can be provided by client device 110 of an end user in response to the client device 110 receiving input that selects an option to reserve an accommodation and/or share the listing with one or more guests. The graphical object generation component 220 processes information associated with the listing that is selected to identify and select one of the templates from the list of templates 400. For example, the graphical object generation component 220 can determine that the information for the listing includes a listing identifier. The graphical object generation component 220 can search the first group of templates 410 to determine whether the listing identifier of the listing matches any listing identifiers associated with the first group of templates 410. In response to determining that the listing identifier matches the listing identifier associated with an individual template of the first group of templates 410, the graphical object generation component 220 retrieves the individual template from the first group of templates 410. The graphical object generation component 220 can then add a set of details corresponding to the selected listing (e.g., host name, reservation dates, guest names, guest identifiers, number of guests, and so forth) to the individual template. The graphical object generation component 220 places or overlays the set of details according to the visual attributes defined for the individual template.

In some cases, the graphical object generation component 220 determines that the listing identifier fails to match any of the listing identifiers associated with the first group of templates 410. In response, the graphical object generation component 220 determines whether a location identifier (e.g., city name, state name, POI name, GPS coordinates, and so forth) associated with the selected listing matches any location identifier in the third group of templates 430. In response to determining that the location identifier matches the location identifier associated with an individual template of the third group of templates 430, the graphical object generation component 220 retrieves the individual template from the third group of templates 430. The graphical object generation component 220 can then add a set of details corresponding to the selected listing (e.g., host name, reservation dates, guest names, guest identifiers, number of guests, and so forth) to the individual template. The graphical object generation component 220 places or overlays the set of details according to the visual attributes defined for the individual template. If multiple templates in the third group of templates 430 include location identifiers that match the location identifier of the selected listing, the graphical object generation component 220 randomly selects, as the individual template one of the templates having the matching location identifier or selects a template with the most matching location attributes for the location identifier of the selected listing.

In some cases, the graphical object generation component 220 determines that the location identifier fails to match any of the location identifiers associated with the third group of templates 430. In response, the graphical object generation component 220 determines whether taxonomy information (e.g., destination tags) associated with the selected listing matches any taxonomy information in the second group of templates 420. The graphical object generation component 220 obtains or generates (e.g., using an LLM prompt and an LLM engine) a set of destination tags for the selected listing. The graphical object generation component 220 compares the set of destination tags for the selected listing with the destination tags stored for each template in the second group of templates 420. The graphical object generation component 220 then selects a best matching template from the second group of templates 420. For example, the graphical object generation component 220 identifies an individual template for which a quantity of destination tags matching the destination tags of the selected listing is the greatest. Namely, the graphical object generation component 220 can determine that the taxonomy information (e.g., destination tags) associated with the listing matches a first number (or quantity) of destination tags corresponding to the taxonomy information of a first template of the third group of templates 430. The graphical object generation component 220 can determine that the taxonomy information (e.g., destination tags) associated with the listing matches a second number (or quantity) of destination tags corresponding to the taxonomy information of a second template of the third group of templates 430. The graphical object generation component 220 selects the second template as the individual template of the third group of templates having the taxonomy information that matches the taxonomy information associated with the listing in response to determining that the second number of tags is greater than the first number of tags.

The graphical object generation component 220 can then add a set of details corresponding to the selected listing (e.g., host name, reservation dates, guest names, guest identifiers, number of guests, and so forth) to the individual template selected from the third group of templates 430. The graphical object generation component 220 places or overlays the set of details according to the visual attributes defined for the individual template. In some cases, the graphical object generation component 220 determines that the information associated with the selected listing fails to match information associated with the first group of templates 410, the second group of templates 420, and the third group of templates 430. In such cases, the graphical object generation component 220 selects as the individual template a random template from the fourth group of templates 440.

In some examples, an end user may desire to perform some action with the listing network platform 142. For example, the user may desire to search for a listing for a reservation, modify one or more reservations held by the listing network platform 142, list a reservation on the listing network platform 142, communicate with a host of a listing on the listing network platform 142, request a refund for a reservation on the listing network platform 142, pay for services on the listing network platform 142, and/or to perform any other available function on the listing network platform 142.

In such cases, a user may initiate contact with the listing network platform 142 through any number of user interaction channels. For example, the user can establish a first user interaction channel with the listing network platform 142 by placing a telephone call using the client device 110 to a service phone number associated with the listing network platform 142. In response to receiving the telephone call, the listing network platform 142 can search a database that associates a telephone number of the client device 110 with an account of the user on the listing network platform 142. As another example, the user can initiate contact with the listing network platform 142 by accessing a GUI associated with the listing network platform 142. Through the GUI, the user can input search criteria by typing in characters of a string that is used to search listings on the listing network platform 142. In some examples, the search criteria are supplied or transmitted from the client device 110 to the graphical object generation component 220.

The reservation component 240 can process the search criteria and can perform a search of the listings information stored in the listing network platform 142 to identify a plurality of listings that match the search criteria. The search criteria can be input by select certain drop-down options. For example, the search criteria can define various attributes, such as a quantity of adults (guests), a quantity of children and/or their respective ages, a minimum and/or maximum duration of stay, and so forth.

In some examples, the reservation component 240 can continuously monitor characters that are being typed into the GUI of the client device 110. The reservation component 240 can continuously search a list of POIs based on one or more partially complete words of the search criteria as the search criteria is being input. The reservation component 240 can search different types of POIs and organize the different types of POIs into a window for presentation to a user of the client device 110. In this way, as the user types in characters of the search criteria, preliminary results are presented to the user to allow the user to autocomplete the search criteria. For example, if the user is typing in the word “pari,” the reservation component 240 can initiate a search for the POIs and identify a plurality of POIs associated with a portion of the incomplete word that is typed in “pari” corresponding to the complete word “Paris.”

The reservation component 240 can also present a search results region in the GUI. The search results region can present a list of graphical objects (e.g., thumbnails) each associated with a respective one of the identified plurality of listings. The graphical objects can include detailed information about each listing that matches the search criteria, such as an image, video, description, and so forth.

Further, the user can select dates using a dates drop-down element to select a specific date range for the temporary stay at an accommodation associated with a listing for a reservation. For example, the user can select the dates drop-down element and a pop-up calendar appears enabling the user to specify the stay in San Francisco is to be specifically from July 16 to July 18. Upon submitting the query, a communication is sent from the programmatic client 116 to the listing sharing system 150. The listing sharing system 150 generates an output that includes a results display of the listings (e.g., graphical objects) matching the query and transmits the output to the programmatic client 116. The user can then select the graphical objects for the listings or navigate to additional pages via page navigational elements.

The reservation component 240 receives input from the client device 110 that selects an individual listing for a particular reservation at an accommodation or stay. In response, the reservation component 240 presents a page that includes various attributes and details about the accommodation including information about a host of the accommodation, rules and restrictions, pictures and videos of the accommodation, and various other information. The page can include an operation for a user to request to reserve the accommodation associated with the listing. In response, the reservation component 240 presents a window or new page that enables the user to input various personal information. The window or new page also includes fields that a user can use to input identification of a number or quantity of co-travelers or guests that will travel as a group with the user to stay at the accommodation. In some cases, the reservation component 240 can receive input that specifies contact information (e.g., email and/or phone number) of each guest that is identified as a co-traveler. In some cases, the reservation component 240 can receive input that identifies a group of travelers by selecting a group identifier. In such cases, the reservation component 240 retrieves automatically names and contact information for each user that was previously included and defined by the group identifier.

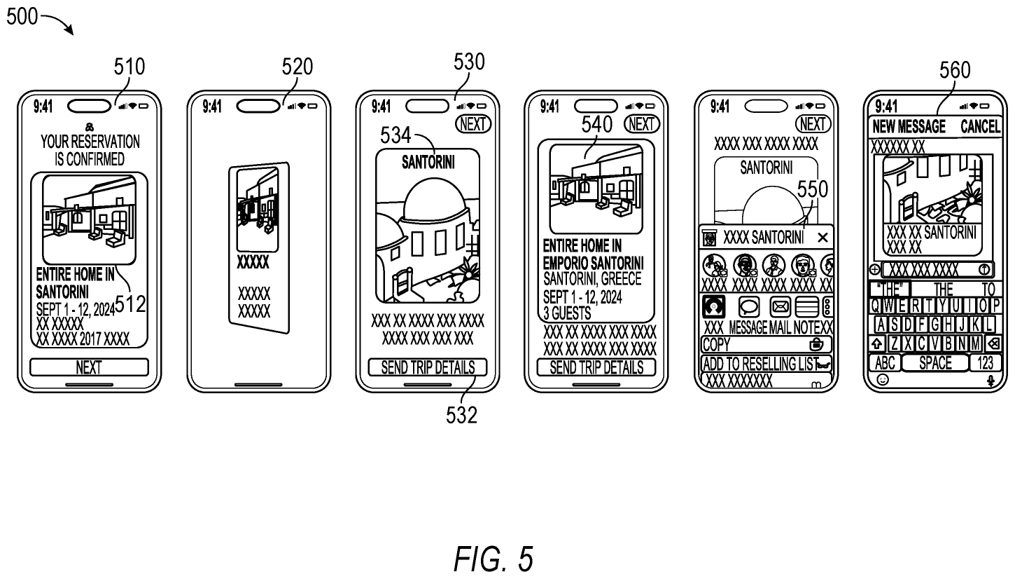

In response to the reservation component 240 determining that one or more guests (co-travelers), the reservation component 240 communicates an identifier of the listing associated with the reservation to the graphical object generation component 220 as a selected listing. The graphical object generation component 220 then uses the list of templates 400 to generate a postcard or graphical object for the listing. The graphical object generation component 220 provides the graphical object to the reservation component 240. The reservation component 240 then presents the graphical object in a graphical user interface of the end user on the client device 110. For example, as shown in FIG. 5, a set of user interfaces 500 can be presented to the user of the client device 110.

The set of user interfaces 500 includes a first user interface 510 that includes the graphical object 512. The graphical object 512 can correspond to the postcard generated by the graphical object generation component 220. The graphical object 512 can include a back side portion (shown in first user interface 510) and a front side portion 534 shown in the third user interface 530. The back side portion of the graphical object 512 can include various details about the reservation, such as number of travelers, travel dates, type of accommodation, one or more pictures of the accommodation or videos of the accommodation, and other suitable information obtained from the listing. The first user interface 510 can receive input that taps the graphical object 512 and, in response, the reservation component 240 toggles between presenting the back side portion to presenting the front side portion 534. The front side portion 534 can include an image or video corresponding to the destination and a name of the city, state and/or POI corresponding to the destination. In some cases, the name of the city, state and/or POI corresponding to the destination is presented in a native language associated with an account of the user and/or guests. In some cases, in the process of transitioning between the back side portion and the front side portion, an animation can be presented that rotates the graphical object 512 from one side to another along a vertical axis. An intermediate portion of this animation is shown in the second user interface 520.

The third user interface 530 can present a share trip details option 532. Selection of the share trip details option 532 can activate the sharing component 260. The sharing component 260 can generate a unique reference or link for the listing being shared including a random sequence of characters. The sharing component 260 can store the link in association with the listing and the graphical object 512.

In some cases, selection of the share trip details option 532 can present the back side portion 540 of the graphical object 512. In response to the share trip details option 532 being selected, the sharing component 260 can present a window 550 for selecting one or more recipients. The window 550 can receive input from the user that specifies contact information (e.g., email address, phone number, and so forth) for one or more guests included in the reservation. In some cases, the window 550 restricts the user from adding contact information for a greater number of recipients than the total number of guests specified in the reservation details. For example, if the user reserved the accommodation with three additional guests, the sharing component 260 restricts the user from specifying or providing contact information for more than three co-travelers or guests.

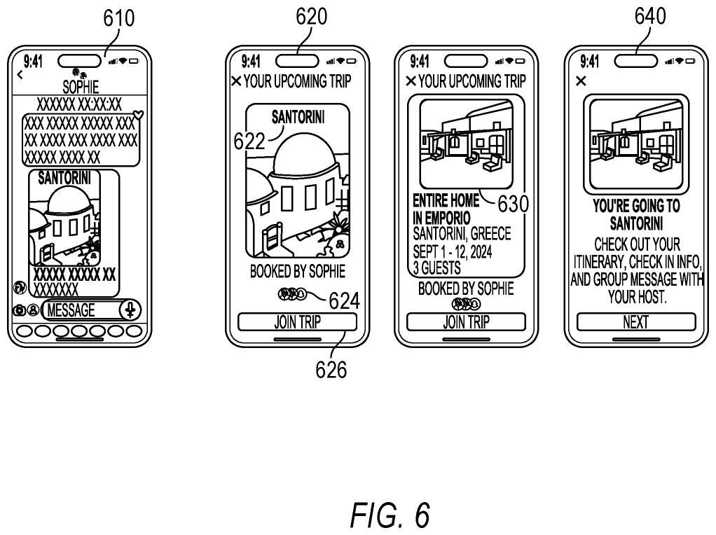

In some cases, the sharing component 260 transmits a message 560 to each of the guests through the contact information provided by the user. The message 560 can include the graphical object 512 and the secure link. As shown in FIG. 6, the graphical object 512 can be presented to a guest on as a message on a user interface 610 of a corresponding client device 110. The user interface 610 can receive input from the guest selecting the graphical object 512. In response, the sharing component 260 determines if the guest has an account with the listing network platform 142. If so, the sharing component 260 launches the application(s) 114 of the listing network platform 142 on the client device 110 of the guest and presents a user interface 620 for the guest to join the trip. In response to determining that the guest does not have an account with the listing network platform 142, the sharing component 260 provides an option for the guest to download and install the application(s) 114 and to create an account with the listing network platform 142.

The application(s) 114 presents the user interface 620 including the front side portion 622 of the graphical object 512. The user interface 620 can receive input from the guest that taps on the front side portion 622. In response, the user interface 620 animates the front side portion 622 rotating about the vertical (or horizontal) axis to present the back side portion 630. The user interface 620 can present a join trip option 626 and identifiers 624 of guests that are associated with the same reservation or listing. The identifiers 624 can include avatars, names, or other visual representations of each guest specified by the user who reserved the accommodation associated with the listing.

In response to receiving input from the guest that selects the join trip option 626, the sharing component 260 adds the username of the guest to a list of active users associated with the listing. Specifically, the sharing component 260 accesses the link associated with the graphical object 512 and determines whether the username corresponding to the guest is authorized to be added to the list of guests associated with the listing. The sharing component 260 determines whether the link is currently in an active or revoked state. In response to determining that the link is currently in an active state, the sharing component 260 enables the user to be added to the list of users associated with the listing. If the link is revoked, the sharing component 260 prevents the user from being added to the list. After adding the user to the list of users associated with the listing, the sharing component 260 presents a user interface 640 welcoming the user to the listing and indicating to the user where the user is going to travel based on the location associated with the listing being shared. In some cases, the sharing component 260 presents a user interface that includes a map of the accommodation and allows the guest to select a particular room within the accommodation. The sharing component 260 can then reserve that room by assigning the name of the guest to the room and can restrict other guests from selecting the same room within the accommodation.

In some examples, the link can be manually revoked by the user who reserved the listing. In some cases, the link can be automatically revoked on or after a specified period has elapsed from an end date or checkout date associated with the reservation included in the listing details. In some cases, the link can be automatically revoked in response to determining that an accommodation for the listing has been canceled. The user who created or made the reservation can specify access rights for each of the guests including what information is available to the guests. For example, the guests can be enabled to view and/or access one or more messages exchanged between the guest and the host of the accommodation. In some cases, the guests can be authorized to communicate directly with the host after the guests are added to the reservation. In some cases, guests can view feedback or a review provided by the guest in relation to the listing for the accommodation. In some cases, the host can provide feedback or a review for the user who reserved the listing for the accommodation and also for any user or guest that has been invited to and joined and associated with the listing for the accommodation.

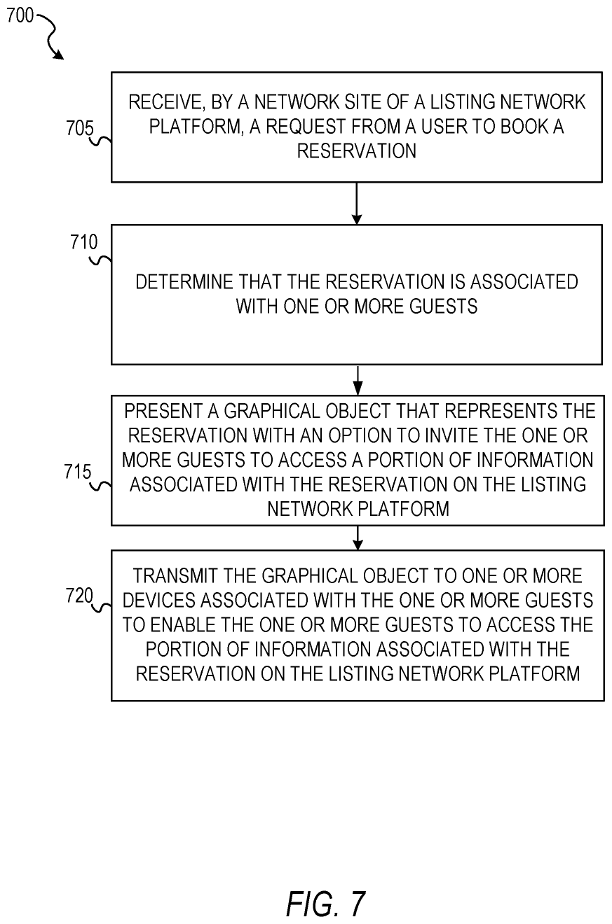

FIGS. 7-9 show flow diagrams of various processes and methods for sharing access to listings on the listing network site, according to some examples.

FIG. 7 shows a flow diagram of various processes and methods 700 for sharing access to listings on the listing network site, according to some examples. These processes and methods 700 can be performed by any component discussed above or below, such as the listing sharing system 150.

At operation 705, the listing sharing system 150 receives a request from a user to book a reservation, as discussed above.

At operation 710, the listing sharing system 150 determines that the reservation is associated with one or more guests, as discussed above.

At operation 715, the listing sharing system 150, in response to determining that the reservation is associated with the one or more guests, presents a graphical object that represents the reservation with an option to invite the one or more guests to access a portion of information associated with the reservation on the listing network platform, as discussed above.

At operation 720, the listing sharing system 150 transmits the graphical object to one or more devices associated with the one or more guests to enable the one or more guests to access the portion of information associated with the reservation on the listing network platform, as discussed above.

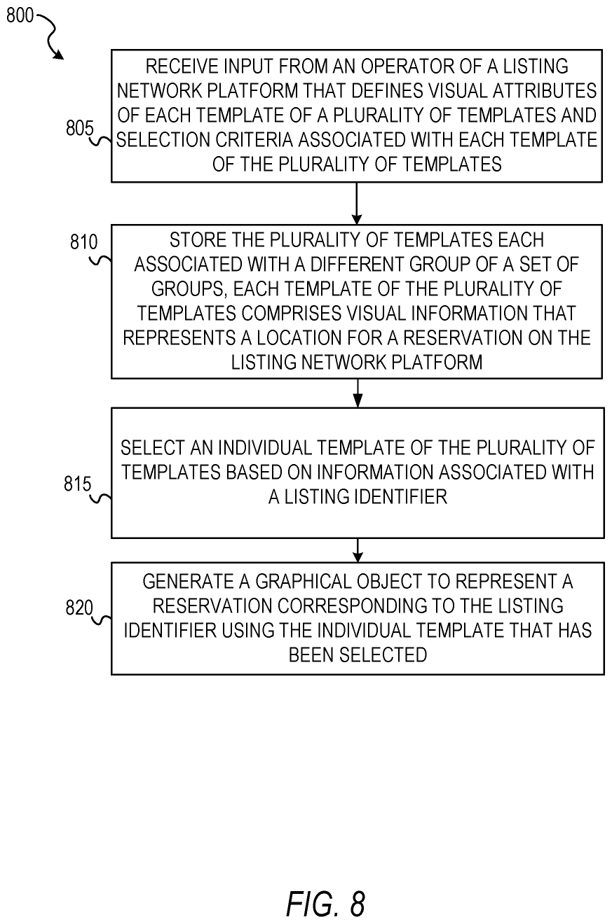

FIG. 8 shows a flow diagram of various processes and methods 800 for sharing access to listings on the listing network site, according to some examples. These processes and methods 800 can be performed by any component discussed above or below, such as the listing sharing system 150.

At operation 805, the listing sharing system 150 receives input from an operator of a listing network platform that defines visual attributes of each template of a plurality of templates and selection criteria associated with each template of the plurality of templates, as discussed above.

At operation 810, the listing sharing system 150 stores the plurality of templates each associated with a different group of a set of groups, each template of the plurality of templates comprises visual information that represents a location for a reservation on the listing network platform, as discussed above.

At operation 815, the listing sharing system 150 selects an individual template of the plurality of templates based on information associated with a listing identifier, as discussed above.

At operation 820, the listing sharing system 150 generates a graphical object to represent a reservation corresponding to the listing identifier using the individual template that has been selected, as discussed above.

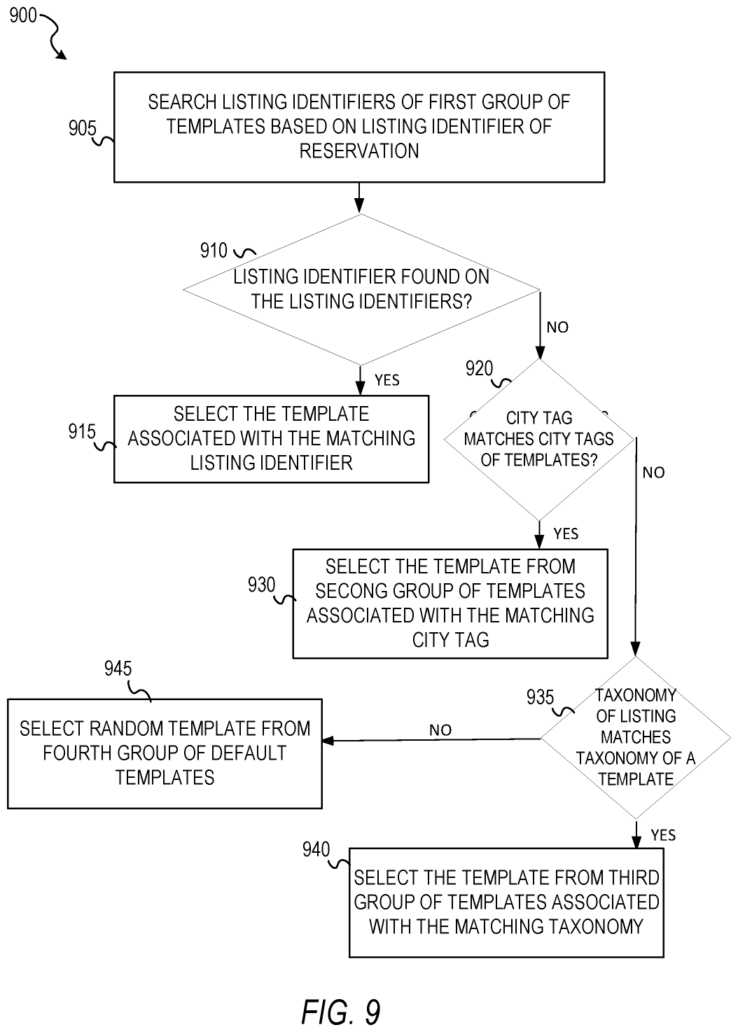

FIG. 9 shows a flow diagram of various processes and methods 900 for sharing access to listings on the listing network site, according to some examples. These processes and methods 900 can be performed by any component discussed above or below, such as the listing sharing system 150. Specifically, as explained in the processes or methods 900, the listing sharing system 150 can match the templates to listings in a specified order where a template is matched to a listing if the template has a matching listing identifier first. If not, the listing sharing system 150 can match the templates to listings based on a destination of the booking (e.g., city information). If a matching destination is not found, the listing sharing system 150 matches the templates to the listings based on taxonomy tags for the destination of the booking. If a matching set of taxonomy tags are not found, the listing sharing system 150 returns a default template. In some cases, templates can be assigned to specific users. In such cases, if a specific user is booking a reservation, a template unique and specific to that user is returned in any suitable portion of the processes or methods 900.

At operation 905, the listing sharing system 150 searches listing identifiers of a first group of templates based on a listing identifier of a reservation, as discussed above.

At operation 910, the listing sharing system 150 determines whether the listing identifier is found on the listing identifiers of the first group of templates, as discussed above. For example, if the listing sharing system 150 determines that the listing identifier matches a listing identifier of a template in the first group of templates, the listing sharing system 150 performs operation 915 to select the template with the matching listing identifier. In response to determining that none of the templates has a listing identifier that matches the listing identifier of the selected listing, the listing sharing system 150 performs operation 920.

At operation 920, the listing sharing system 150, determines whether a city tag (location identifier, such as a city name, state name, POI name, GPS information, and so forth) matches location identifiers of a second group of templates, as discussed above. For example, if the listing sharing system 150 determines that the location identifier matches a location identifier of a template in the second group of templates, the listing sharing system 150 performs operation 930 to select the template with the matching location identifier. In response to determining that none of the templates has a location identifier that matches the location identifier of the selected listing, the listing sharing system 150 performs operation 935.

At operation 935, the listing sharing system 150 compares taxonomy information of the listing with taxonomy information associated with templates in a third group of templates, as discussed above. For example, if the listing sharing system 150 determines that the taxonomy information of the listing best matches taxonomy information of a template in the third group of templates, the listing sharing system 150 performs operation 940 to select the template with the matching taxonomy information. In response to determining that none of the templates has taxonomy information that matches the taxonomy information of the selected listing, the listing sharing system 150 performs operation 945.

At operation 945, the listing sharing system 150 randomly selects a template from a fourth group of default templates, as discussed above. The selected template from operation 915, 930, 940, and/or 945 can then be used to generate a graphical object to represent a listing for a reservation.

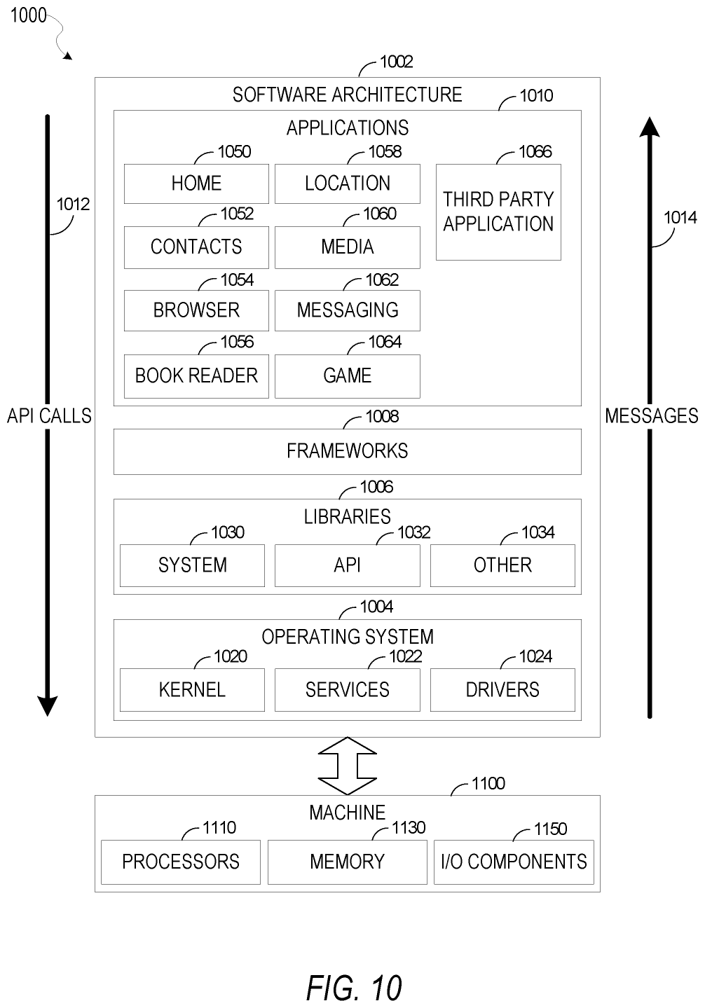

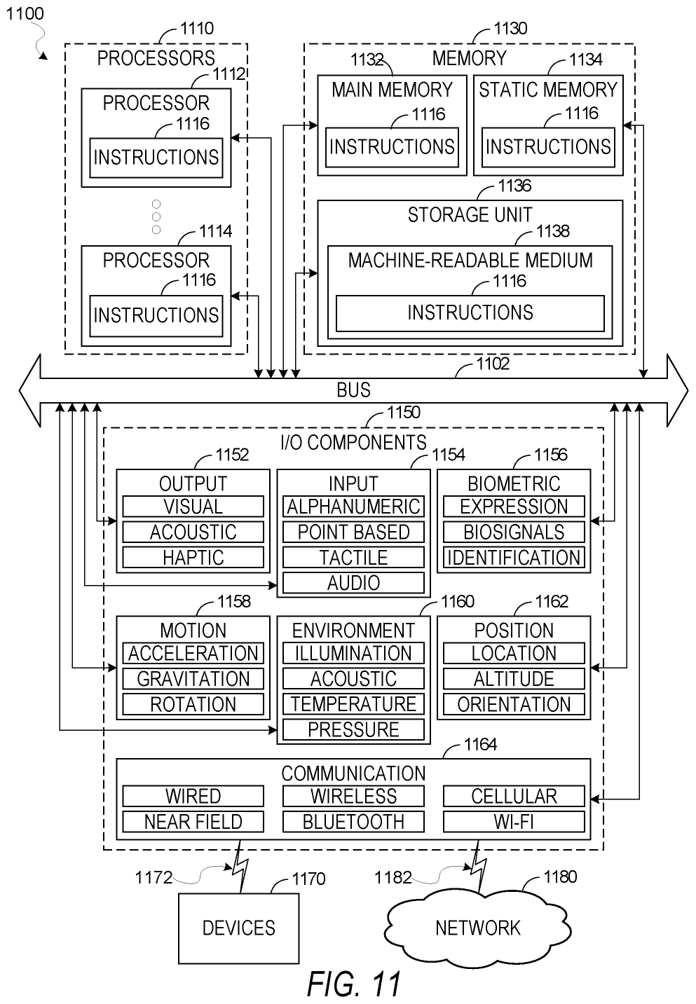

FIG. 10 is a block diagram 1000 illustrating an architecture of software 1002, which can be installed on any one or more of the devices described above. FIG. 10 is merely a non-limiting example of a software architecture, and it will be appreciated that many other architectures can be implemented to facilitate the functionality described herein. In various embodiments, the software 1002 is implemented by hardware such as a machine 1100 of FIG. 11 that includes processors 1110, memory 1130, and input/output (I/O) components 1150. In this example architecture, the software 1002 can be conceptualized as a stack of layers where each layer may provide a particular functionality. For example, the software 1002 includes layers such as an operating system 1004, libraries 1006, frameworks 1008, and applications 1010. Operationally, the applications 1010 invoke API calls 1012 through the software stack and receive messages 1014 in response to the API calls 1012, consistent with some embodiments.

In various implementations, the operating system 1004 manages hardware resources and provides common services. The operating system 1004 includes, for example, a kernel 1020, services 1022, and drivers 1024. The kernel 1020 acts as an abstraction layer between the hardware and the other software layers, consistent with some embodiments. For example, the kernel 1020 provides memory management, processor management (e.g., scheduling), component management, networking, and security settings, among other functionalities. The services 1022 can provide other common services for the other software layers. The drivers 1024 are responsible for controlling or interfacing with the underlying hardware, according to some embodiments. For instance, the drivers 1024 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 1006 provide a low-level common infrastructure utilized by the applications 1010. The libraries 1006 can include system libraries 1030 (e.g., C standard library) that can provide functions such as memory allocation functions, string manipulation functions, mathematic functions, and the like. In addition, the libraries 1006 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1006 can also include a wide variety of other libraries 1034 to provide many other APIs to the applications 1010.

The frameworks 1008 provide a high-level common infrastructure that can be utilized by the applications 1010, according to some embodiments. For example, the frameworks 1008 provide various graphic user interface (GUI) functions, high-level resource management, high-level location services, and so forth. The frameworks 1008 can provide a broad spectrum of other APIs that can be utilized by the applications 1010, some of which may be specific to a particular operating system or platform.

In an example embodiment, the applications 1010 include a home application 1050, a contacts application 1052, a browser application 1054, a book reader application 1056, a location application 1058, a media application 1060, a messaging application 1062, a game application 1064, and a broad assortment of other applications such as a third-party application 1066. According to some embodiments, the applications 1010 are programs that execute functions defined in the programs. Various programming languages can be employed to create one or more of the applications 1010, structured in a variety of manners, such as object-oriented programming languages (e.g., Objective-C, Java, or C++) or procedural programming languages (e.g., C or assembly language). In a specific example, the third-party application 1066 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1066 can invoke the API calls 1012 provided by the operating system 1004 to facilitate the functionality described herein.

FIG. 11 illustrates a diagrammatic representation of a machine 1100 in the form of a computer system within which a set of instructions may be executed for causing the machine to perform any one or more of the methodologies discussed herein, according to an example embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a PC, a tablet computer, a laptop computer, a netbook, an STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136, all accessible to the processors 1110 such as via the bus 1102. The main memory 1132, the static memory 1134, and storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

The various memories (i.e., 1130, 1132, 1134, and/or memory of the processor(s) 1110) and/or storage unit 1136 may store one or more sets of instructions and data structures (e.g., software) embodying or utilized by any one or more of the methodologies or functions described herein. These instructions (e.g., the instructions 1116), when executed by processor(s) 1110, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1180 may be an ad hoc network, an intranet, an extranet, a VPN, an LAN, a WLAN, a WAN, a WWAN, an MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another or may be combined in various ways. All possible combinations and sub combinations are intended to fall within the scope of this disclosure. In addition, certain method or process blocks may be omitted in some implementations.

1. A method comprising:
receiving, by a network site of a listing network platform, a request from an individual user to book a reservation comprising an accommodation at a destination;
determining that a listing for the reservation comprising the accommodation is associated with a group of users comprising one or more guests traveling together to stay at the destination that includes the accommodation, the group of users comprising the individual user and the one or more guests that are co-traveling with the individual user;
in response to determining that the listing for the reservation that is associated with the group of users traveling together to stay at the destination that includes the accommodation, generating a graphical object based on information associated with the listing comprising one or more attributes of the destination that includes the accommodation including retrieving, from a storage device, data associated with the listing to populate fields of the graphical object to represent the reservation using a selected template; and
presenting the graphical object that represents the reservation with an option to invite the one or more guests to access a portion of information associated with the reservation on the listing network platform; and
transmitting the graphical object to one or more devices associated with the one or more guests to enable the one or more guests to access the portion of information associated with the reservation on the listing network platform.

2. The method of claim 1, comprising:
receiving input from the user comprising contact information for the one or more guests; and
transmitting the graphical object to the one or more devices using the contact information.

3. The method of claim 1, comprising:
determining whether a listing identifier of the listing for the reservation corresponds to one of a set of listing identifiers of a first group of templates, each template in the first group of templates being associated with a respective listing identifier of the set of listing identifiers; and
in response to determining that the listing identifier of the listing for the reservation corresponds to the one of the set of listing identifiers of the first group of templates, selecting, as the selected template, an individual template of the first group of templates that is associated with the listing identifier.

4. The method of claim 1, further comprising:
receiving input from the user comprising an indication of a number of guests to associate with the reservation prior to receiving the request to book the reservation; and
preventing the portion of information associated with the reservation from being accessed by more than the number of guests associated with the reservation.

5. The method of claim 1, wherein the graphical object comprises an interactive postcard that visually represents a location associated with the reservation, the postcard comprising a front portion that includes information identifying the location, the postcard comprising a back portion that includes details associated with the reservation, the postcard being animated to toggle between the front portion and the back portion in response to user input.

6. The method of claim 3, comprising:
associating the first group of templates of a plurality of templates with the respective listing identifiers of the set of listing identifiers of different listings on the listing network platform; and
associating a second group of templates of the plurality of templates with other destination information corresponding to the destination.

7. The method of claim 5, wherein the details associated with the reservation includes dates for the reservation, total number of guests, identifiers of the guests, name of a host, and type of accommodation.

8. The method of claim 5, further comprising:
toggling between presenting the front portion and presenting the back portion in response to input that taps on current portion of the postcard being presented.

9. The method of claim 1, further comprising:
causing the graphical object to be presented in a graphical user interface on an individual device of the one or more devices associated with an individual guest of the one or more guests;
causing the graphical user interface to present a join trip option; and
in response to receiving input from the individual guest that selects the join trip option, enabling the individual guest to access the portion of the information associated with the reservation.

10. The method of claim 9, wherein the portion of the information includes one or more messages exchanged between the user and a host of the reservation.

11. The method of claim 1, further comprising:
receiving input from the user to invite the one or more guests to access the portion of the information associated with the reservation;
in response to receiving the input, generating a link comprising a unique text string; and
associating the link with the reservation along with an expiration date for revoking access to the link.

12. The method of claim 11, further comprising:
receiving a request from an individual guest of the one or more guests to join the reservation, the request comprising the unique text string;
verifying that the unique text string is valid; and
in response to determining that the unique text string is valid, adding an identifier of the individual guest to the reservation to enable the individual guest to access the portion of the information associated with the reservation.

13. The method of claim 11, further comprising:
receiving a request from an individual guest of the one or more guests to join the reservation, the request comprising the unique text string;
verifying that the unique text string is valid; and
in response to determining that the unique text string is invalid, preventing the individual guest from being added to the reservation.

14. The method of claim 11, further comprising:
invalidating the link in response to determining that at least one of the reservations has been canceled, a revocation request has been received from the user, or the user has checked out of an accommodation associated with the reservation.

15. The method of claim 1, further comprising:
selecting an individual template from a plurality of templates based on data associated with the reservation; and
generating the graphical object using the selected individual template.

16. The method of claim 15, further comprising:
storing the plurality of templates;
associating a first group of templates of the plurality of templates with respective listing identifiers of different listings on the listing network platform;
associating a second group of templates of the plurality of templates with destination information; and
associating a third group of templates of the plurality of templates with respective taxonomy information.

17. The method of claim 16, further comprising:
determining whether a listing identifier of a listing for the reservation corresponds to one of the listing identifiers of the first group of templates; and
in response to determining that the listing identifier of the reservation corresponds to one of the listing identifiers of the first group of templates, selecting, as the individual template, the template associated with the listing identifier.

18. The method of claim 17, further comprising:
in response to determining that the listing identifier of the reservation fails to correspond to one of the listing identifiers of the first group of templates, determining whether a city tag matches the destination information for one of the templates in the second group of templates;
in response to determining that the city tag matches the destination information for one of the templates in the second group of templates, selecting, as the individual template, the template one of the templates in the second group that matches the city tag;
in response to determining that the city tag fails to match the destination information for one of the templates in the second group of templates, determining whether taxonomy information is available for the listing of the reservation;
in response to determining that taxonomy information is unavailable for the listing of the reservation, selecting a default template as the individual template;
in response to determining that taxonomy information is available for the listing of the reservation, comparing the taxonomy information associated with the listing with the taxonomy information associated with the third group of templates; and
selecting one of the third group of templates having the taxonomy information that matches the taxonomy information associated with the listing.

19. A system comprising:
one or more processors of a machine; and
a memory storing instruction that, when executed by the one or more processors, cause the machine to perform operations comprising:
receiving, by a network site of a listing network platform, a request from an individual user to book a reservation comprising an accommodation at a destination;
determining that a listing for the reservation comprising the accommodation is associated with a group of users comprising one or more guests traveling together to stay at the destination that includes the accommodation, the group of users comprising the individual user and the one or more guests that are co-traveling with the individual user;
in response to determining that the listing for the reservation that is associated with the group of users traveling together to stay at the destination that includes the accommodation, generating a graphical object based on information associated with the listing comprising one or more attributes of the destination that includes the accommodation including retrieving, from a storage device, data associated with the listing to populate fields of the graphical object to represent the reservation using a selected template; and
presenting the graphical object that represents the reservation with an option to invite the one or more guests to access a portion of information associated with the reservation on the listing network platform; and
transmitting the graphical object to one or more devices associated with the one or more guests to enable the one or more guests to access the portion of information associated with the reservation on the listing network platform.

20. A machine-readable storage device embodying instructions that, when executed by a machine, cause the machine to perform operations comprising:
receiving, by a network site of a listing network platform, a request from an individual user to book a reservation comprising an accommodation at a destination;
determining that a listing for the reservation comprising the accommodation is associated with a group of users comprising one or more guests traveling together to stay at the destination that includes the accommodation, the group of users comprising the individual user and the one or more guests that are co-traveling with the individual user;
in response to determining that the listing for the reservation that is associated with the group of users traveling together to stay at the destination that includes the accommodation, generating a graphical object based on information associated with the listing comprising one or more attributes of the destination that includes the accommodation including retrieving, from a storage device, data associated with the listing to populate fields of the graphical object to represent the reservation using a selected template; and
presenting the graphical object that represents the reservation with an option to invite the one or more guests to access a portion of information associated with the reservation on the listing network platform; and
transmitting the graphical object to one or more devices associated with the one or more guests to enable the one or more guests to access the portion of information associated with the reservation on the listing network platform.
